(19) United States
(12) Patent Application Publication
(10) Pub. No.: US 2026/0125067 A1
(43) Pub. Date: May 7, 2026

(54) IDENTIFICATION AND TRANSFER OF OPERATIONAL CONTROLS OF AN AUTONOMOUS VEHICLE

(71) Applicant: Kyndryl, Inc., New York, NY (US)

(72) Inventor: Cesar Augusto Rodriguez Bravo, Alajuela (CR)

(21) Appl. No.: 18/938,345

(22) Filed: Nov. 6, 2024

(51) Int. Cl. B60W 50/08; B60W 30/14; B60W 50/02; B60W 50/10; B60W 60/00; G07C 5/00

(52) U.S. Cl. CPC B60W 50/085; B60W 30/146; B60W 50/0225; B60W 50/10; B60W 60/001; G07C 5/008; B60W 2556/45; B60W 2756/10

(57) ABSTRACT

Computer-implemented methods for identifying and transferring operational controls of an autonomous vehicle to an external device are described herein. Aspects include receiving a pairing request from a user device, a user account being associated with the user device. Aspects also include receiving presence data from a physical input device in an autonomous vehicle indicating that a user is present in the autonomous vehicle. Aspects further include determining a permissions profile based on the user account and sensor data from the autonomous vehicle in response to receiving the presence data. The autonomous vehicle can include operational controls. Aspects also include identifying a subset of the operational controls of the autonomous vehicle available to the user device based on the user account and the permissions profile.

Aspects further include authorizing the user device to control the subset of the operational controls of the autonomous vehicle.

### BACKGROUND

The present invention generally relates to computer systems, and more specifically, to computer-implemented methods, computer systems, and computer program products configured and arranged to identify and transfer operational control of an autonomous vehicle to an external user device.

An autonomous vehicle, also known as a self-driving car, is a vehicle that is capable of sensing its environment and operating without human involvement. A passenger is not required to take control of the vehicle at any time. In some autonomous vehicles, instruments to control the car may not be available in the cabin of the vehicle. For example, some autonomous vehicles may not have a steering wheel, accelerator, or brakes available in the cabin of the vehicle.

Autonomous vehicles rely on sensors, actuators, complex algorithms, machine learning systems, and powerful processors to execute software. Autonomous vehicles create and maintain a map of their surroundings based on a variety of sensors situated in different parts of the vehicle. Radar sensors monitor the position of nearby vehicles. Video cameras detect traffic lights, read road signs, track other vehicles, and look for pedestrians. Light detection and ranging (LiDAR) sensors bounce pulses of light off the environment to measure distances, detect road edges, identify lane markings, identify the presence of an object, and the like. Ultrasonic sensors in the wheels detect curbs and other vehicles when parking. Sophisticated software then processes all the collected data, plots a path, and sends instructions to the actuators of the vehicle, which control acceleration, braking, and steering. Hard-coded rules, obstacle avoidance algorithms, predictive modeling, and object recognition help the software follow traffic rules and navigate obstacles.

### SUMMARY

Embodiments of the present invention are directed to computer-implemented methods to transfer operational control of an autonomous vehicle to an external device. A non-limiting computer-implemented method includes receiving a pairing request from a user device. A user account can be associated with the user device. The method also includes receiving presence data from a physical input device in an autonomous vehicle indicating that a user is present in the autonomous vehicle. The method further includes determining a permissions profile based on the user account and sensor data from the autonomous vehicle in response to receiving the presence data. The autonomous vehicle can include operational controls. The method further include identifying a subset of the operational controls of the autonomous vehicle available to the user device based on the user account and the permissions profile. The method also includes authorizing the user device to control the subset of the operational controls of the autonomous vehicle.

In one embodiment of the present invention, the method includes receiving a second presence data from the physical input device in the autonomous vehicle. The method also includes obtaining current sensor data from the autonomous vehicle and the user device in response to receiving the second presence data. The method further includes determining that an emergency situation has occurred based on the current sensor data from the autonomous vehicle and the user device. The method also includes initiating a failover system that disables a primary system of the autonomous vehicle and activates a secondary subsystem. The method further includes authorizing the user device to control all operational controls for driving the autonomous vehicle using the secondary subsystem. In some embodiments, the secondary subsystem is a cloud service secondary subsystem or a locally-stored read-only clone copy of the primary system of the autonomous vehicle. In some embodiments, the method further includes generating a current status of the autonomous vehicle based on the current sensor data. In some embodiments, environmental data of the autonomous vehicle is obtained from the current sensor data. The method also includes transmitting a message that can include the current status of the autonomous vehicle, the environmental data from the autonomous vehicle, and the user account associated with the user device to an external user support system associated with the autonomous vehicle for performance of remedial actions in response to the emergency situation.

In one embodiment of the present invention, the operational controls of the autonomous vehicle can include wiper controls, music controls, light controls for inside the autonomous vehicle, a maximum speed control for the autonomous vehicle, window controls, driving controls, or driving mode selection controls.

In one embodiment of the present invention, the physical input device of the autonomous vehicle can be a button in the autonomous vehicle, a fingerprint sensor, or a camera in the autonomous vehicle.

In one embodiment of the present invention, the permissions profile can include rules for granting authorization for the user device to control the subset of the operational controls of the autonomous vehicle based on a location of the autonomous vehicle, a user account attribute, a user account type, or preferences of the user account.

According to another non-limiting embodiment of the invention, a system having a memory having computer-readable instructions and one or more processors for executing the computer readable instructions, the computer readable instructions controlling the one or more processors to perform operations. The operations include receiving a pairing request from a user device. A user account can be associated with the user device. The operations also include receiving presence data from a physical input device in an autonomous vehicle indicating that a user is present in the autonomous vehicle. The operations further include determining a permissions profile based on the user account and sensor data from the autonomous vehicle in response to receiving the presence data. The autonomous vehicle can include operational controls. The operations further include identifying a subset of the operational controls of the autonomous vehicle available to the user device based on the user account and the permissions profile. The operations also include authorizing the user device to control the subset of the operational controls of the autonomous vehicle.

According to another non-limiting embodiment of the invention, a computer program product is provided. The computer program product includes a computer-readable storage medium having program instructions embodied therewith, the program instructions executable by a processor to cause the processor to perform operations. The operations include receiving a pairing request from a user device. A user account can be associated with the user device. The operations also include receiving presence data from a physical input device in an autonomous vehicle indicating that a user is present in the autonomous vehicle. The operations further include determining a permissions profile based on the user account and sensor data from the autonomous vehicle in response to receiving the presence data. The autonomous vehicle can include operational controls. The operations further include identifying a subset of the operational controls of the autonomous vehicle available to the user device based on the user account and the permissions profile. The operations also include authorizing the user device to control the subset of the operational controls of the autonomous vehicle.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a block diagram of an example computer system for use in conjunction with one or more embodiments of the present invention;

FIG. 2 depicts a block diagram of an example system for transferring operational control of an autonomous vehicle to an external user device in accordance with one or more embodiments of the present invention;

FIG. 3 is a data flow diagram for transferring operational control of an autonomous vehicle to an external user device in accordance with one or more embodiments of the present invention;

FIG. 4 is a flowchart of a computer-implemented method for transferring operational control of an autonomous vehicle to an external user device in accordance with one or more embodiments of the present invention;

FIG. 5 is a flowchart of a computer-implemented method for initiating a failover system in an autonomous vehicle in accordance with one or more embodiments of the present invention;

FIG. 6 depicts a cloud computing environment in accordance with one or more embodiments of the present invention; and

FIG. 7 depicts abstraction model layers in accordance with one or more embodiments of the present invention.

### DETAILED DESCRIPTION

Disclosed herein are methods, systems, and computer program products for identifying and transferring operational controls of an autonomous vehicle to an external user device. An autonomous vehicle, also known as a self-driving car, is a vehicle that is capable of sensing its environment and operating without human involvement. A passenger is not required to take control of the vehicle at any time. However, autonomous vehicles are subject to different types of vulnerabilities, such as cybersecurity attacks, software errors, hardware errors, and interpretation errors that can make the autonomous vehicle act unpredictably or erratically. When the autonomous vehicle behaves in an unexpected and possibly unsafe manner due to such vulnerabilities, a passenger of the autonomous vehicle may feel unsafe and helpless, especially if the autonomous vehicle does not have instruments in the cabin of the vehicle to allow the passenger to take control when emergencies occur. The systems and methods described herein provide the ability to transfer operational control of the autonomous vehicle to a user device of the user that is external to the autonomous vehicle.

In some embodiments, the autonomous vehicle is equipped with a physical input device, such as a button or dial, which is located inside the vehicle. A passenger can board the vehicle and request to pair their user device with the autonomous vehicle. The system requests the passenger to interact with the physical input device of the vehicle prior to granting the pairing request. Presence data is generated in response to the user interacting with the physical input device and is transmitted to the system. By requesting the passenger interact with the physical input device located inside the vehicle, the system verifies that the person requesting access to the autonomous vehicle is physically located inside the vehicle to reduce the likelihood of a cyberattack on the autonomous vehicle.

After the user device has been paired with the autonomous vehicle, the systems and methods described herein determine operational controls of the autonomous vehicle that can be transferred to the user device associated with the user. Examples of user devices can include smartphones, smart glasses, Internet of Things (IoT) devices, smartwatches, and/or augmented reality devices. The operational controls of an autonomous vehicle refer to the ability to direct or adjust features and functionalities of the autonomous car. Examples of operational controls of an autonomous vehicle can include wiper controls, music controls, light controls for inside the autonomous vehicle, a maximum speed control for the autonomous vehicle, window controls, driving controls, or driving mode selection controls. In some embodiments, the system can obtain data from the user device and the autonomous vehicle, such as user account information, user device type, user account attributes, sensor data from sensors of the autonomous vehicle, environmental data about the environment around the autonomous vehicle, and the like. The system can generate or update a permissions profile associated with the user account of the user device. In some embodiments, the permissions profile can include rules for granting authorization for a user device to control operational controls of the autonomous vehicle. The rules can be based on different types of data, such as user account preferences, user account type, user account attributes, current location of the autonomous vehicle, and the like.

In some embodiments, the system obtains a list of all the operational controls of the autonomous vehicle. Using the permissions profile associated with the user account, the system can generate a subset of the operational controls available to transfer to the user device associated with the user. The system can authorize the user device to control the subset of operational controls of the autonomous vehicle, enabling the user to control features and functions of the autonomous vehicle using their user device.

In some embodiments, the systems and methods described herein also provide a failover system in case the autonomous vehicle is out of control due to a cyberattack or malfunction. A second indication or presence data set from the physical input device can be received by the autonomous vehicle. The system can determine that the second set of presence data from the physical input device indicates that an emergency situation might have occurred. The system gathers data from the autonomous vehicle and the user device, analyzes the data and determines if an emergency situation has occurred. If the system determines that an emergency situation has occurred, a failover system is activated. Upon activating the failover system, the systems and methods described herein can disable the primary system of the autonomous vehicle and transition to a secondary subsystem. The secondary subsystem can be a cloud service subsystem or a locally-stored clean cloned copy of the primary system. The system transitions to the secondary subsystem and facilitates connectivity with the user device. In some embodiments, the system determines to transfer operational controls to drive the autonomous vehicle to the user device.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

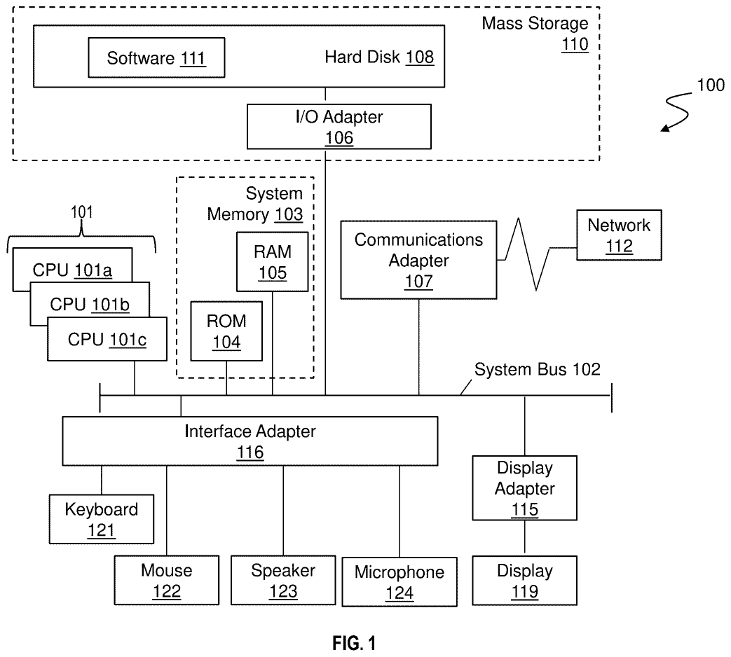

Turning now to FIG. 1, a computer system 100 is generally shown in accordance with one or more embodiments of the invention. The computer system 100 can be an electronic, computer framework comprising and/or employing any number and combination of computing devices and networks utilizing various communication technologies, as described herein. The computer system 100 can be easily scalable, extensible, and modular, with the ability to change to different services or reconfigure some features independently of others. The computer system 100 may be, for example, a server, desktop computer, laptop computer, tablet computer, or smartphone. In some examples, computer system 100 may be a cloud computing node. Computer system 100 may be described in the general context of computer system executable instructions, such as program modules, being executed by a computer system. Generally, program modules may include routines, programs, objects, components, logic, data structures, and so on that perform particular tasks or implement particular abstract data types. Computer system 100 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, the computer system 100 has one or more central processing units (CPU(s)) 101a, 101b, 101c, etc., (collectively or generically referred to as processor(s) 101). The processors 101 can be a single-core processor, multi-core processor, computing cluster, or any number of other configurations. The processors 101, also referred to as processing circuits, are coupled via a system bus 102 to a system memory 103 and various other components. The system memory 103 can include a read only memory (ROM) 104 and a random-access memory (RAM) 105. The ROM 104 is coupled to the system bus 102 and may include a basic input/output system (BIOS) or its successors like Unified Extensible Firmware Interface (UEFI), which controls certain basic functions of the computer system 100. The RAM is read-write memory coupled to the system bus 102 for use by the processors 101. The system memory 103 provides temporary memory space for operations of said instructions during operation. The system memory 103 can include random access memory (RAM), read only memory, flash memory, or any other suitable memory systems.

The computer system 100 comprises an input/output (I/O) adapter 106 and a communications adapter 107 coupled to the system bus 102. The I/O adapter 106 may be a small computer system interface (SCSI) adapter that communicates with a hard disk 108 and/or any other similar component. The I/O adapter 106 and the hard disk 108 are collectively referred to herein as a mass storage 110.

Software 111 for execution on the computer system 100 may be stored in the mass storage 110. The mass storage 110 is an example of a tangible storage medium readable by the processors 101, where the software 111 is stored as instructions for execution by the processors 101 to cause the computer system 100 to operate, such as is described herein below with respect to the various Figures. Examples of computer program product and the execution of such instruction is discussed herein in more detail. The communications adapter 107 interconnects the system bus 102 with a network 112, which may be an outside network, enabling the computer system 100 to communicate with other such systems. In one embodiment, a portion of the system memory 103 and the mass storage 110 collectively store an operating system, which may be any appropriate operating system to coordinate the functions of the various components shown in FIG. 1.

Additional input/output devices are shown as connected to the system bus 102 via a display adapter 115 and an interface adapter 116. In one embodiment, the adapters 106, 107, 115, and 116 may be connected to one or more I/O buses that are connected to the system bus 102 via an intermediate bus bridge (not shown). A display 119 (e.g., a screen or a display monitor) is connected to the system bus 102 by the display adapter 115, which may include a graphics controller to improve the performance of graphics intensive applications and a video controller. A keyboard 121, a mouse 122, a speaker 123, a microphone 124, etc., can be interconnected to the system bus 102 via the interface adapter 116, which may include, for example, a Super I/O chip integrating multiple device adapters into a single integrated circuit. Suitable I/O buses for connecting peripheral devices such as hard disk controllers, network adapters, and graphics adapters typically include common protocols, such as the Peripheral Component Interconnect (PCI) and the Peripheral Component Interconnect Express (PCIe). Thus, as configured in FIG. 1, the computer system 100 includes processing capability in the form of the processors 101, storage capability including the system memory 103 and the mass storage 110, input means such as the keyboard 121, the mouse 122, and the microphone 124, and output capability including the speaker 123 and the display 119.

In some embodiments, the communications adapter 107 can transmit data using any suitable interface or protocol, such as the internet small computer system interface, among others. The network 112 may be a cellular network, a radio network, a wide area network (WAN), a local area network (LAN), or the Internet, among others. An external computing device may connect to the computer system 100 through the network 112. In some examples, an external computing device may be an external webserver or a cloud computing node.

It is to be understood that the block diagram of FIG. 1 is not intended to indicate that the computer system 100 is to include all of the components shown in FIG. 1. Rather, the computer system 100 can include any appropriate fewer or additional components not illustrated in FIG. 1 (e.g., additional memory components, embedded controllers, modules, additional network interfaces, etc.). Further, the embodiments described herein with respect to computer system 100 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

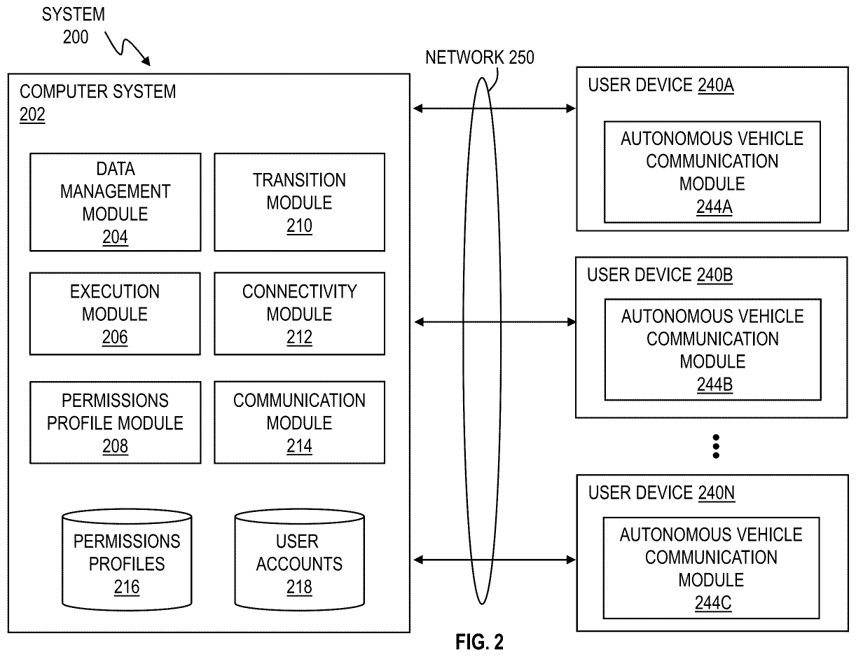

FIG. 2 depicts a block diagram of an example system 200 configured for transferring operational control of an autonomous vehicle to an external user device according to one or more embodiments. The system 200 includes a computer system 202 configured to communicate over a network 250 with many different user devices, such as user device 240A, user device 240B, through user device 240N. The user devices 240A, 240B, through 240N can generally be referred to as user device 240, are utilized to access the communication environment, and are utilized for communication between one another, such as for emails, phone calls, video calls, messaging including short message service (SMS) and multimedia messaging service (MMS), etc. The user device 240 can be a personal computer or laptop. The user device 240 can be a mobile device such as a cellular phone or tablet, or a smart device. A smart device is an electronic device, generally connected to other devices or networks via different wireless protocols that can operate to some extent interactively. Several notable types of smart devices are smartphones, smart speakers, tablets, smartwatches, smart bands, smart glasses, and many others.

The network 250 can be a wired and/or wireless communication network, and the communication network includes a telecommunications network, the public switched telephone network (PTSN), voice over IP (VOIP) network, etc. The communication network includes cellular networks, satellite networks, etc.

The user devices 240 can include various software and hardware components including software applications (apps) for communicating with one another over the network 250 as understood by one of ordinary skill in the art. The computer system 202, user device(s) 240, data management module 204, execution module 206, permissions profile module 208, transition module 210, connectivity module 212, communication module 214, permissions profiles datastore 216, user accounts datastore 218, etc., can include functionality and features of the computer system 100 in FIG. 1, including various hardware components and various software applications such as software 111 which can be executed as instructions on one or more processors 101 in order to perform actions according to one or more embodiments of the invention. The data management module 204, execution module 206, permissions profile module 208, transition module 210, connectivity module 212, communication module 214, permissions profiles datastore 216, user accounts datastore 218 can include, be integrated with, and/or call other pieces of software, algorithms, application programming interfaces (APIs), etc., to operate as discussed herein.

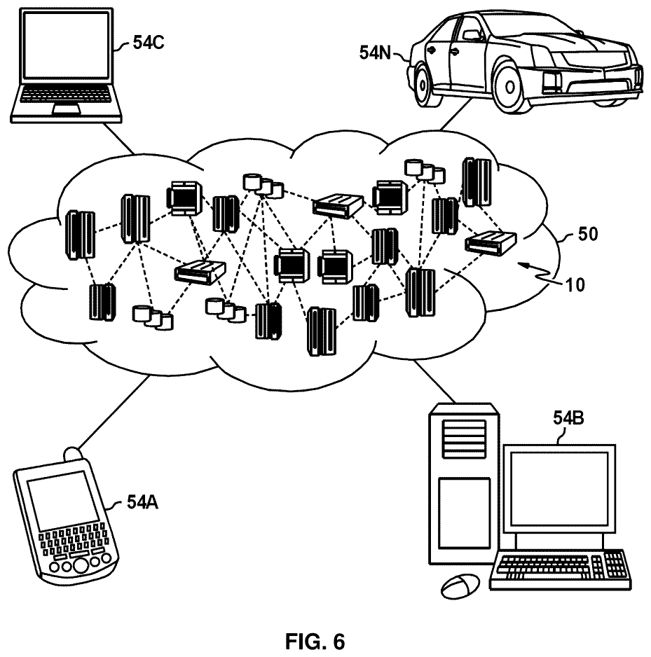

The computer system 202 may be representative of numerous computer systems and/or distributed computer systems configured to identify and transfer operational controls of an autonomous vehicle to a user device 240. In some embodiments, operational controls of an autonomous vehicle may refer to the ability to direct or adjust features and functionalities of the autonomous car. Examples of operational controls of an autonomous vehicle can include wiper controls, music controls, light controls for inside the autonomous vehicle, a maximum speed control for the autonomous vehicle, window controls, driving controls, or driving mode selection controls. The computer system 202 can be part of a cloud computing environment such as a cloud computing environment 50 depicted in FIG. 6, as discussed further herein.

In some embodiments, a user device 240 includes an autonomous vehicle communication (AVC) module, such as AVC module 244A, 244B through 244N, generally referred to as AVC module 244. The AVC module 244 communicates with the computer system 202. For example, the AVC module 244 of a user device 240 can communicate with the computer system 202 to establish a connection or pair with the computer system 202 of the autonomous vehicle. The AVC module 244 transmits data for a user account for a user of the user device 240. In some embodiments, the AVC module 244 transmits a request for operational controls of the autonomous vehicle to be transferred to the user device 240 for a user of the user device 240. In one or more embodiments, the AVC module 244 may be installed on the user device 240 prior to ride on the autonomous vehicle. In one or more embodiments, the AVC module 244 may include secure protocols for communicating with the computer system 202 of the autonomous vehicle.

In some embodiments, the AVC module 244 receives authorization for operational controls of the autonomous vehicle. The AVC module 244 presents the operational controls on the user device 240. The AVC module 244 receives user input to modify one or more operational controls of the autonomous vehicle and communicates the commands to the computer system 202 for execution by the autonomous vehicle. In some embodiments, the user input can be voice commands, gestures captured by the AVC module 244, selection or modification of values of the operational controls presented by the AVC module 244, or the like.

In some embodiments, the computer system 202 can include one or more components to identify and transfer operational controls of an autonomous vehicle to a user device 240. For example, the computer system 202 can include a data management module 204, an execution module 206, a permissions profile module 208, a transition module 210, a connectivity module 212, a communication module 214, a permissions profiles datastore 216, and/or a user accounts datastore 218.

In some embodiments, the data management module 204 of the computer system 202 receives the data from an AVC module, such as AVC module 244A, of a user device, such as user device 240A. The data management module 204 processes the data received from the user device 240A to establish a connection or pair the user device 240 with the computer system 202 of the autonomous vehicle. In some embodiments, the data management module 204 obtains, monitors, and/or analyzes sensor data from the autonomous vehicle and the user device 240. For example, the data management module 204 can obtain sensor data from sensors of the autonomous vehicle, such as a current location from a GPS, light levels from a light sensor, a current speed of the autonomous vehicle, and the like. In some embodiments, the data management module 204 can obtain data from the user device 240, such as device type, user account data, input/output capabilities, and the like. The data management module 204 can use the user account data received from the AVC module 244A to retrieve additional information associated with the user account from a user accounts datastore, such as user accounts datastore 218, which may include user preferences, user account attributes, user account type, and the like.

In some embodiments, the execution module 206 of the computer system 202 of the autonomous vehicle detects input or receives presence data from a physical input device located inside the autonomous vehicle that indicates that a user is inside the autonomous vehicle. In response to receiving the presence data, execution of identifying and transferring operational controls of the autonomous vehicle to the user device 240 or initiation of a failover system of the autonomous vehicle is initiated. Examples of the physical input device can include, but are not limited to, a physical button or dial, a fingerprint sensor, a camera, a microphone, or the like. In one or more embodiments, examples of the physical input device may include any type of sensor for capturing biometric data to perform biometric authentication including fingerprint recognition, facial recognition, voice recognition, iris recognition, palm recognition, etc. In some embodiments, the physical input device can be an existing button or dial of the autonomous vehicle that has been designated as the physical input device for the computer system 202. In response to receiving the presence data from the physical input device after receiving a request to pair the user device 240 with the autonomous vehicle, the execution module 206 transmits a message to the permissions profile module 208 to initiate identification and transfer of operational controls to the user device 240.

In some embodiments, the permissions profile module 208 of the computer system 202 of the autonomous vehicle may receive the message from the execution module 206 and obtain data from the data management module 204 from the user device 240. The permissions profile module 208 identifies the user account associated with user device 240 and retrieves an existing permissions profile for the user 302 from a permissions profile datastore, such as permissions profiles datastore 216. If a permissions profile associated with the user account does not exist, the permissions profile module 208 generates a new permissions profile and associates it with the user account. A permissions profile can include rules for granting authorization for a user device 240 to control operational controls of the autonomous vehicle.

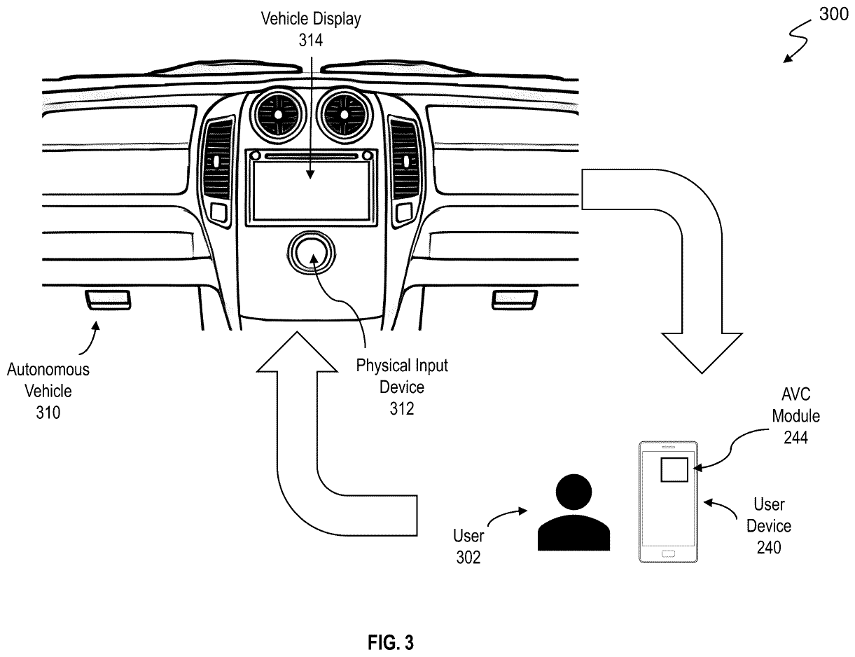

In some embodiments, the permissions profile module 208 identifies all operational controls of the autonomous vehicle using the sensor data obtained from different sensors of the autonomous vehicle. In some embodiments, the permissions profile module 208 can update or add rules to the permissions profile rules based on the operational controls of the autonomous vehicle and various other factors, as discussed further in FIG. 3. The permissions profile module 208 communicates with the AVC module 244A of user device 240A to transfer control of the operational controls to the user device 240.

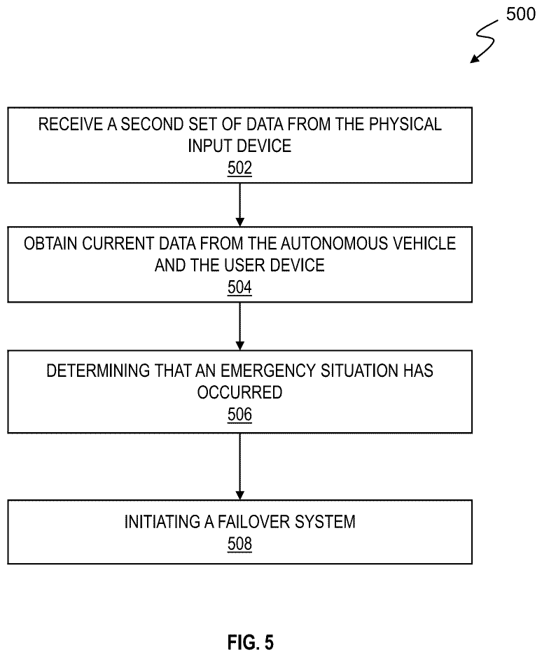

In some embodiments, the execution module 206 receives presence data from the physical input device and determines that an emergency situation has occurred, as further discussed in FIG. 5. In response to determining that an emergency situation has occurred, the execution module 206 activates a failover system and communicates with the transition module 210. In some embodiments, the execution module 206 transmits data associated with the emergency situation to the transition module 210.

The transition module 210 of the computer system 202 of the autonomous vehicle disables the primary system of the autonomous vehicle and executes a secure failover to a secondary subsystem. In some embodiments, the secondary subsystem may be a secure connection to a cloud service secondary subsystem. In some embodiments, the secondary subsystem may be a read-only system which can be a cloned clean copy of the primary system stored locally on the autonomous vehicle. In some embodiments, the autonomous vehicle is equipped with a secondary subsystem stored locally on the autonomous vehicle and a cloud service secondary subsystem, and the autonomous vehicle selects a subsystem for the failover transition based on the data received from the execution module 206 associated with the emergency situation.

In some embodiments, the transition module 210 communicates with a connectivity module 212. The connectivity module 212 obtains data from the data management module 204 for the user device 240 and data from the transition module 210 for the secondary subsystem. The connectivity module 212 manages establishing connectivity between the user device 240 and the secondary subsystem in real time to ensure that the user is able utilize the user device 240 to adjust the operational controls for driving the autonomous vehicle when it has transitioned to the secondary subsystem.

In some embodiments, the computer system 202 of the autonomous vehicle includes a communication module 214. The communication module 214 can receive a message from the execution module 206 that the failover system has been activated. The communication module 214 communicates with the data management module 204 to obtain current sensor data from the autonomous vehicle and generates a current status of the autonomous vehicle. In some embodiments, environmental data is obtained from the current sensor data from the autonomous vehicle. The current status of the autonomous vehicle can include a report that includes a current location of the autonomous vehicle, identification of any portion or operational function of the vehicle that has become disabled, a current speed and direction of travel of the autonomous vehicle, and the like. In some embodiments, the current status can indicate that the autonomous vehicle is currently functioning properly and still traveling to the requested destination. The current status can indicate if one or more components of the autonomous vehicle is not functioning properly or if the autonomous vehicle has stopped or deviated from the path to the requested destination. Environmental data can include data obtained from sensors of the autonomous vehicle that pertain to the surrounding environment. For example, sensors may include light sensors that indicate light levels outside, rain sensors that detect moisture on the windshield to indicate possible rain, and the like. In some embodiments, the environmental data can include images captured by cameras of the autonomous vehicle of the surrounding environment at the time the emergency situation is detected. Examples of the environmental data can include road conditions, weather conditions, traffic conditions, and the like using current sensor data obtained from the sensors of the autonomous vehicle. The communication module 214 can generate and transmit a message that includes the current status of the autonomous vehicle, the environmental data from the autonomous vehicle, and the user account associated with the user device 240 to an external user support system associated with the autonomous vehicle for further remedial actions in response to the emergency situation.

FIG. 3 is a data flow diagram 300 for transferring operational control of an autonomous vehicle 310 to an external user device 240. In some embodiments, a user 302 enters an autonomous vehicle, such as autonomous vehicle 310. The user 302 can use the AVC module 244, which may be part of a mobile application on a user device 240, to request to pair the user device 240 with the computer system 202 of the autonomous vehicle 310. In some embodiments, the user 302 provides a username and password to authenticate their identity prior to the AVC module 244 transmitting the pairing request to the data management module 204 of the computer system 202. In some embodiments, the AVC module 244 may also transmit additional data with the pairing request, such as user account information associated with the user 302, a device type of the user device 240, input and output capabilities of the user device 240, and the like. In some embodiments, the AVC module 244 can request the user to specify a preferred method to connect with the computer system 202 of the autonomous vehicle 310, such as Bluetooth®, Wi-Fi, radio frequency, or the like.

The data management module 204 receives the pairing request and uses a vehicle display 314 of the autonomous vehicle 310 to present instructions requesting for the user 302 to push or otherwise interact with a physical input device 312 of the autonomous vehicle 310. In some embodiments, the physical input device 312 is used to verify that the user 302 is physically inside the autonomous vehicle 310. This may be to prevent cyberattacks or other actions in which a third party takes control of the autonomous vehicle 310 without being physically present in the autonomous vehicle 310.

In some embodiments, the physical input device 312 may be a fingerprint reader, and the data management module 204 presents instructions on the vehicle display 314 that requests the user to scan their fingerprint to verify their presence in the vehicle as well as a form of secondary authentication. The physical input device 312 can be a camera, and the data management module 204 requests the user to take a picture through the camera of the autonomous vehicle 310 to verify their presence. In some embodiments, the data management module 204 uses the image captured by the camera for facial recognition as a secondary authentication method for the user 302.

In some embodiments, the physical input device 312 may be an existing button or other mechanism (e.g., dial, trigger, etc.) in the autonomous vehicle 310 that has been repurposed or remapped to the computer system 202. The data management module 204 presents instructions on the vehicle display 314 of the autonomous vehicle 310 requesting the user to press the button or otherwise interact with physical input device 312 to verify that the user 302 is present in the autonomous vehicle 310. In response to the user interacting with the physical input device 312, presence data indicating that the user 302 is present inside the autonomous vehicle 310 is generated and transmitted to the execution module 206.

The execution module 206 of the computer system 202 receives presence data from the physical input device 312 which indicates that the user 302 is inside the autonomous vehicle 310. In some embodiments, the execution module 206 uses the presence data received to authenticate the user 302, such as data from a fingerprint scanner or image from a camera. In response to receiving the presence data, the execution module 206 then initiates the process for identifying and transferring operational features to the user device 240.

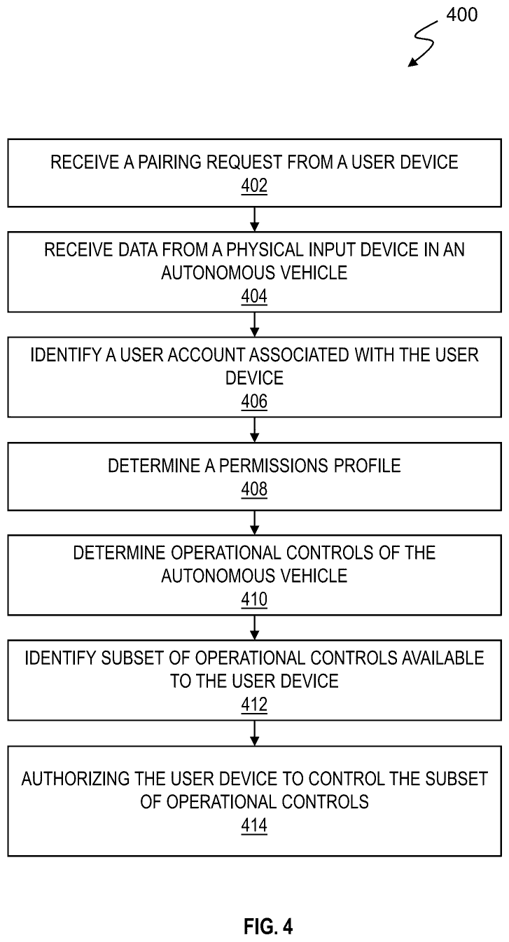

In some embodiments, in response to receiving the presence data, the execution module 206 communicates with the permissions profile module 208 to identify and determine operational controls of the autonomous vehicle 310 available to the user 302, as described in further detail in FIG. 4. The permissions profile module 208 uses the user account data and sensor data obtained from different sensors of the autonomous vehicle 310 to identify operational controls of the autonomous vehicle 310. In some embodiments, the permissions profile module 208 retrieves an existing permissions profile for the user 302 from a permissions profiles datastore 216. If a permissions profile for the user account does not exist, the permissions profile module 208 generates a new permissions profile and associates it with the user account.

The permissions profile module 208 uses sensor data received from the different sensors of the autonomous vehicle 310 to populate or update the permissions profile. The permissions profile module 20 uses the permissions profile associated with user account to determine or identify a subset of operational controls from the list of operational controls of the autonomous vehicle 310 available to the user 302.

The permissions profile module 208 transmits the subset of operational controls to the AVC module 244 of the user device 240 which then presents an interface to adjust or control the operational controls granted to the user device 240. In one or more embodiments, the permissions profile module 208 may cause a graphical user interface (GUI) of operational controls to be displayed by the AVC module 244 on the user device 240.

When a user 302 adjusts the operational controls granted to the user device 240, the AVC module 244 transmits the data indicating the adjustments to the execution module 206 of the computer system 202, which can then facilitate implementing the adjustments received from the user device 240 in the autonomous vehicle 310.

Now referring to FIG. 4, a flowchart of a computer-implemented method 400 for transferring operational control of an autonomous vehicle 310 to an external user device 240 in accordance with one or more embodiments of the present invention is depicted. At block 402 of the computer-implemented method 400, the data management module 204 of the computer system 202 is configured to receive a pairing request from the user device 240. In some embodiments, a user 302 that has boarded an autonomous vehicle 310 can use the AVC module 244 of their user device 240 to request to pair the user device 240 with the autonomous vehicle 310. The AVC module 244 can be part of a mobile application executing on the user device 240 which requires the user 302 to provide a username and password to authenticate their identity prior to transmitting the pairing request to the data management module 204 of the computer system 202 of the autonomous vehicle 310. In some embodiments, the pairing request may include additional data, such as user account information associated with the user 302, a device type of the user device 240, input and output capabilities of the user device 240, and/or user preferences associated with the user account, such as a preferred method to connect with the computer system 202 of the autonomous vehicle 310.

Next at block 404, presence data is received from the physical input device 312 in the autonomous vehicle 310. The presence data indicates that a user 302 is currently inside the autonomous vehicle 310. In response to receiving the pairing request from the user device 240, the data management module 204 displays instructions on a vehicle display 314 of the autonomous vehicle 310 that request the user 302 to interact with physical input device 312 (e.g., press the button, turn the dial, etc.) to verify that the user 302 is physically present in the autonomous vehicle 310. As discussed above, in some embodiments, the physical input device 312 may be a fingerprint reader, a camera, an existing button or other mechanism (e.g., dial, trigger, etc.) in the autonomous vehicle 310 that has been repurposed or remapped to the computer system 202, or the like. In response to the user 302 interacting with the physical input device 312, presence data indicating that the user 302 is inside the autonomous vehicle 310 is transmitted to the execution module 206 of the computer system 202.

Next at block 406, a user account associated with the user device 240 is identified. The execution module 206 of the computer system 202 receives the presence data from the physical input device 312. In some embodiments, the execution module 206 may use the presence data received from the physical input device 312 to authenticate the user 302, such as data from a fingerprint scanner or image from a camera. The execution module 206 then communicates with the data management module 204 to obtain additional data associated with the user device 240. The data management module 204 uses the data received from the pairing request to obtain user account data from the user accounts datastore 218. Examples of user account data can include user preferences, user account attributes, user account type, and the like.

Next at block 408, a permissions profile is determined. In some embodiments, the execution module 206 transmits a message to the permissions profile module 208 in response to receiving the presence data from the physical input device 312. A permissions profile can include rules for granting authorization for a user device 240 to control operational controls of the autonomous vehicle 310. In some embodiments, the permissions profile associated with a user account is analyzed and adjusted for each new trip or encounter the user 302 has with an autonomous vehicle 310 to ensure that current data is considered for each session. For example, the destination requested by the user 302, the vehicle type of the autonomous vehicle 310, environmental conditions (e.g., weather, traffic, etc.), and other factors can impact the different operational controls of the autonomous vehicle 310 that are available to transfer to the user device 240 of a user 302.

In some embodiments, the permissions profile module 208 determines if a permissions profile associated with the user account exists. If a permissions profile for the user account does not exist, the permissions profile module 208 generates a new permissions profile and associates it with the user account. If a permissions profile for the user account does exist, the permissions profile module 208 retrieves the existing permissions profile for the user 302 from a permissions profiles datastore 216.

The permissions profile module 208 uses sensor data obtained by the data management module 204 from the different sensors of the autonomous vehicle 310 to populate or update the permissions profile. For example, the permissions profile module 208 may obtain the current location of the autonomous vehicle 310 from the GPS of the autonomous vehicle 310. Based on the current location, the permissions profile module 208 may add rules to the permissions profile for granting authorization to the user device 240, such as geofencing rules based on a location of the autonomous vehicle 310 that limit adjustments to operational controls of the autonomous vehicle 310. For example, if the permissions profile module 208 determines that the autonomous vehicle 310 is currently within a city, the permissions profile module 208 can add a rule to the permissions profile indicating that the operational control for adjusting the maximum speed of the autonomous vehicle 310 should not be available to the user 302.

The permissions profile module 208 can evaluate user account attributes to apply rules for authorizing the user device 240 to control certain operational controls of the autonomous vehicle 310. For example, the permissions profile module 208 determines to grant access to the operational controls for adjusting the speed of the autonomous vehicle 310 to user accounts that have high ratings (e.g., 5 stars on a 5-star scale) and/or that are older than a set period of time (e.g., user account older than 3 years).

In some embodiments, the permissions profile module 208 determines to apply the rules for granting authorization to operational controls based on the type of user account. For example, user accounts can be categorized as a standard account, a premium account, or a business account. Each of the different types of accounts are associated with a different set of rules granting authorization for different operational controls of the autonomous vehicle 310. In some embodiments, the permissions profile module 208 determines to apply the rules for granting authorization to operational controls based on user preferences or manually associated permissions specified for the user account. For example, a user account can have a manually associated rule granting the user device 240 authorization to access music controls which may not be typical for that type of user account.

Next at block 410, operational controls of autonomous vehicle 310 are determined. In some embodiments, the permissions profile module 208 obtains data from the data management module 204 to identify and determine operational controls of the autonomous vehicle 310. The permissions profile module 208 uses the sensor data obtained by the data management module 204 from different sensors of the autonomous vehicle 310 to identify all available operational controls of the autonomous vehicle 310. Examples of operational controls can include controls for driving the autonomous vehicle 310 (e.g., steering, braking, etc.), wiper controls, music controls, light controls for inside the autonomous vehicle 310, a maximum speed control for the autonomous vehicle 310, window controls, and/or driving mode selection controls.

Next at block 412, a subset of operational controls available to the user device 240 are identified. The permissions profile module 208 determines or identifies a subset of operational controls available to transfer to the user device 240 of the user 302 from the list of operational controls of the autonomous vehicle 310 based on the permissions profile associated with the user account of the user 302. The permissions profile module 208 evaluates the rules of the permissions profile and identifies the subset of operational controls that are available to transfer to the user device 240 of the user 302.

Next at block 414, the user device 240 is authorized to control the subset of operational controls. The permissions profile module 208 transmits the subset of operational controls to the AVC module 244 of the user device 240, which then presents an interface to adjust or control the operational controls granted to the user device 240. In some embodiments, the permissions profile module 208 displays the subset of operational controls available to transfer to the user device 240 of the user 302 on the vehicle display 314 and requests the user 302 to select the operational controls they would like transferred to their user device 240. For example, the subset can include controls for the wipers, controls for the windows, and controls for playing music. If the user 302 only wishes to control the music, they can select the operational controls from the list on the vehicle display 314. The permissions profile module 208 receives the selection and then authorizes only the operational controls for playing music to the user device 240. The AVC module 244 presents an interface to adjust or control the operational controls for playing music on the user device 240.

When a user 302 adjusts the operational controls granted to the user device 240 using the interface of the AVC module 244, the AVC module 244 captures and transmits the data indicating the requested adjustments to the execution module 206 of the computer system 202, which can then facilitate implementing the adjustments received from the user device 240 in the autonomous vehicle 310.

Now referring to FIG. 5, a flowchart of a computer-implemented method 500 for initiating a failover system in an autonomous vehicle 310 in accordance with one or more embodiments of the present invention is depicted. The method 500 begins at block 502 by receiving a second set of presence data from the physical input device 312 of the autonomous vehicle 310. In some embodiments, the execution module 206 of the computer system 202 of the autonomous vehicle 310 receives a second set of presence data from the physical input device 312. In response to receiving the second set of presence data, the execution module 206 presents a message to the vehicle display 314 of the autonomous vehicle 310 and/or the user device 240 by the AVC module 244 requesting confirmation that the user 302 is requesting operational controls to drive the autonomous vehicle 310 or that an emergency situation has occurred.

If the user 302 provides data indicating that transmission of the second set of presence data from the physical input device 312 was in error, no further action is taken by the execution module 206. If the user 302 provides data confirming the request for operational controls to drive the autonomous vehicle 310 or that an emergency situation has occurred, the method proceeds to block 504.

At block 504, the execution module 206 obtains current sensor data from the autonomous vehicle 310 and the user device 240. The execution module 206 communicates with the data management module 204 to obtain the current sensor data from the autonomous vehicle 310 and the user device 240. For example, the data management module 204 can query all of the sensors or components of the autonomous vehicle 310 to identify any portion or operational function of the operational vehicle that has become damaged or disabled, a current speed and direction of travel of the autonomous vehicle 310, images captured from cameras of the autonomous vehicle 310, and the like. The data management module 204 can obtain data from the user device 240, such as a GPS location, requested destination location for the trip in the autonomous vehicle 310, and the like. The data management module 204 provides the current sensor data from the autonomous vehicle 310 and the user device 240 to the execution module 206.

At block 506, the execution module 206 analyzes the current data to determine that an emergency situation has occurred. In some embodiments, the execution module 206 uses predetermined thresholds or rules to determine whether there is an emergency situation that necessitates activating the failover system of the autonomous vehicle 310. For example, the execution module 206 can analyze the current sensor data to determine that a portion of the autonomous vehicle 310 has been damaged or disabled, a component of the autonomous vehicle 310 has suffered a cyberattack, a software error or hardware error has been detected, or there has been an interpretation error that is causing the autonomous vehicle 310 to act inconsistently or erratically.

At block 508, in response to determining that an emergency situation has occurred, the execution module 206 activates or initiates a failover system. In some embodiments, the execution module 206 communicates with the transition module 210. The transition module 210 disables the primary system of the autonomous vehicle 310 and executes a secure failover to a secondary subsystem. In some embodiments, the secondary subsystem may be a secure connection to a cloud service secondary subsystem or a read-only system which can be a cloned clean copy of the primary system stored locally on the autonomous vehicle. In some embodiments, the autonomous vehicle 310 is equipped with a secondary subsystem stored locally on the autonomous vehicle 310 and a cloud service secondary subsystem and selects a secondary subsystem for the failover transition based on data received from the execution module 206 associated with the emergency situation. In some embodiments, the transition module 210 captures system preferences from the primary system of the autonomous vehicle 310 prior to disabling it. The transition module 210 transfers and applies the system preferences to the secondary subsystem. In some embodiments, the system preferences may include the user preferences applied to the primary system, such as preferred connection method, pre-set operational control values, and the like.

In some embodiments, the transition module 210 communicates with the connectivity module 212, which then obtains data from the data management module 204 for the user device 240. The transition module 210 obtains data associated with the secondary subsystem from the transition module 210. The connectivity module 212 facilitates and manages establishing connectivity between the user device 240 and the secondary subsystem.

In some embodiments, the execution module 206 of the computer system 202 of the autonomous vehicle 310 communicates to the communication module 214 that the failover system has been activated. The communication module 214 generates a current status of the autonomous vehicle 310 based on the current sensor data and environmental data is obtained from the current sensor data of the autonomous vehicle 310 from the data management module 204. In some embodiments, the current status of the autonomous vehicle 310 can include a report that includes a current location of the autonomous vehicle 310, identification of any portion or operational function of the autonomous vehicle 310 that has become disabled, a current speed and direction of travel of the autonomous vehicle 310, and the like. In some embodiments, the data management module 204 may obtain environmental data from current sensor data of the autonomous vehicle 310, such as light levels outside of the vehicle from light sensors, rain conditions from the rain sensors that detect moisture on the windshield, images captured by cameras of the autonomous vehicle 310 of the surrounding environment at the time the emergency situation is detected, and the like. The communication module 214 can generate and transmit a message that includes the current status of the autonomous vehicle 310, the environmental data from the autonomous vehicle 310, and the user account associated with the user device 240 to an external user support system associated with the autonomous vehicle 310. In some embodiments, an agent or administrator can review the message received at the external user support system and determine any additional remedial actions to implement or perform, such as contacting emergency services, dispatching another autonomous vehicle 310 to the location for the user 302 to transfer to or use, or dispatching roadside assistance. In one or more embodiments, the external user support system can include one or more computer systems having the functionality of computer system 100 and can be part of a cloud computing environment such as the cloud computing environment 50 depicted in FIG. 6.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:
On-demand self-service: a cloud consumer can unilaterally provision computing capabilities, such as server time and network storage, as needed automatically without requiring human interaction with the service's provider.
Broad network access: capabilities are available over a network and accessed through standard mechanisms that promote use by heterogeneous thin or thick client platforms (e.g., mobile phones, laptops, and PDAs).
Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).
Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.
Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:
Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.
Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.
Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:
Private cloud: the cloud infrastructure is operated solely for an organization. It may be managed by the organization or a third party and may exist on-premises or off-premises.
Community cloud: the cloud infrastructure is shared by several organizations and supports a specific community that has shared concerns (e.g., mission, security requirements, policy, and compliance considerations). It may be managed by the organizations or a third party and may exist on-premises or off-premises.
Public cloud: the cloud infrastructure is made available to the general public or a large industry group and is owned by an organization selling cloud services.
Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

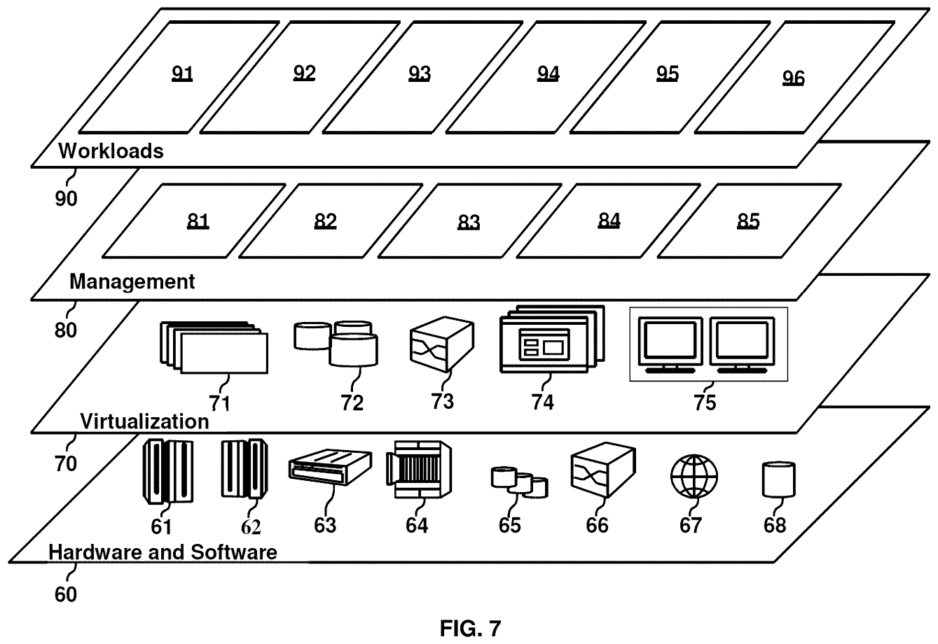

Referring now to FIG. 6, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described herein above, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 7 are intended to be illustrative only and that computing nodes 10 and cloud computing environment 50 can communicate with any type of computerized device over any type of network and/or network addressable connection (e.g., using a web browser).

Referring now to FIG. 7, a set of functional abstraction layers provided by cloud computing environment 50 (depicted in FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and workloads and functions 96. Examples of workloads and functions 96 includes managing communications between an autonomous vehicle 310 and a user device 240, determining a user account associated with the user device 240, determining a permissions profile based on data from the autonomous vehicle 310 and the user device 240, and identifying operational controls of the autonomous vehicle 310 that can be transferred to the user device 240. The workloads and functions 96 facilitate the transfer of the operational controls of the autonomous vehicle 310 to the user device 240. The workloads and functions 96 also includes a system that detects an emergency situation and initiates a failover system in the autonomous vehicle 310 that delegate or transfers the operational controls for driving the autonomous vehicle to the user device 240 or a secondary subsystem through a cloud service.

Various embodiments of the present invention are described herein with reference to the related drawings. Alternative embodiments can be devised without departing from the scope of this invention. Although various connections and positional relationships (e.g., over, below, adjacent, etc.) are set forth between elements in the following description and in the drawings, persons skilled in the art will recognize that many of the positional relationships described herein are orientation-independent when the described functionality is maintained even though the orientation is changed. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. As an example of an indirect positional relationship, references in the present description to forming layer “A” over layer “B” include situations in which one or more intermediate layers (e.g., layer “C”) is between layer “A” and layer “B” as long as the relevant characteristics and functionalities of layer “A” and layer “B” are not substantially changed by the intermediate layer(s).

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for the purposes of illustration and description but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted, or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
receiving a pairing request from a user device, a user account being associated with the user device;
receiving presence data from a physical input device in an autonomous vehicle indicating that a user is present in the autonomous vehicle;
in response to receiving the presence data, determining a permissions profile based on the user account and sensor data from the autonomous vehicle, the autonomous vehicle comprising operational controls;
identifying a subset of the operational controls of the autonomous vehicle available to the user device based on the user account and the permissions profile; and
authorizing the user device to control the subset of the operational controls of the autonomous vehicle.

2. The computer-implemented method of claim 1, further comprising:
receiving a second presence data from the physical input device in the autonomous vehicle;
in response to receiving the second presence data, obtaining current sensor data from the autonomous vehicle and the user device;
determining that an emergency situation has occurred based on the current sensor data from the autonomous vehicle and the user device;
initiating a failover system that disables a primary system of the autonomous vehicle and activates a secondary subsystem; and
authorizing the user device to control the operational controls for driving the autonomous vehicle using the secondary subsystem.

3. The computer-implemented method of claim 2, wherein the secondary subsystem is a cloud service secondary subsystem or a locally-stored read-only clone copy of the primary system of the autonomous vehicle.

4. The computer-implemented method of claim 2, further comprising:
generating a current status of the autonomous vehicle based on the current sensor data, wherein environmental data of the autonomous vehicle is obtained from the current sensor data; and
transmitting a message comprising the current status of the autonomous vehicle, the environmental data from the autonomous vehicle, and the user account associated with the user device to an external user support system associated with the autonomous vehicle for performance of remedial actions in response to the emergency situation.

5. The computer-implemented method of claim 1, wherein the operational controls of the autonomous vehicle comprise wiper controls, music controls, light controls for inside the autonomous vehicle, a maximum speed control for the autonomous vehicle, window controls, driving controls, or driving mode selection controls.

6. The computer-implemented method of claim 1, wherein the physical input device of the autonomous vehicle comprises a button in the autonomous vehicle, a fingerprint sensor, or a camera in the autonomous vehicle.

7. The computer-implemented method of claim 1, wherein the permissions profile comprises rules for granting authorization for the user device to control the subset of the operational controls of the autonomous vehicle based on a location of the autonomous vehicle, a user account attribute, a user account type, or preferences of the user account.

8. A system comprising:
a memory having computer readable instructions; and
one or more processors for executing the computer readable instructions, the computer readable instructions controlling the one or more processors to perform operations comprising:
receiving a pairing request from a user device, a user account being associated with the user device;
receiving presence data from a physical input device in an autonomous vehicle indicating that a user is present in the autonomous vehicle;
in response to receiving the presence data, determining a permissions profile based on the user account and sensor data from the autonomous vehicle, the autonomous vehicle comprising operational controls;
identifying a subset of the operational controls of the autonomous vehicle available to the user device based on the user account and the permissions profile; and
authorizing the user device to control the subset of the operational controls of the autonomous vehicle.

9. The system of claim 8, wherein the operations further comprise:
receiving a second presence data from the physical input device in the autonomous vehicle;
in response to receiving the second presence data, obtaining current sensor data from the autonomous vehicle and the user device;
determining that an emergency situation has occurred based on the current sensor data from the autonomous vehicle and the user device;
initiating a failover system that disables a primary system of the autonomous vehicle and activates a secondary subsystem; and
authorizing the user device to control operational controls for driving the autonomous vehicle using the secondary subsystem.

10. The system of claim 9, wherein the secondary subsystem is a cloud service secondary subsystem or a locally-stored read-only clone copy of the primary system of the autonomous vehicle.

11. The system of claim 9, wherein the operations further comprise:
generating a current status of the autonomous vehicle based on the current sensor data, wherein environmental data of the autonomous vehicle is obtained from the current sensor data; and
transmitting a message comprising the current status of the autonomous vehicle, the environmental data from the autonomous vehicle, and the user account associated with the user device to an external user support system associated with the autonomous vehicle for performance of remedial actions in response to the emergency situation.

12. The system of claim 8, wherein the operational controls of the autonomous vehicle comprise wiper controls, music controls, light controls for inside the autonomous vehicle, a maximum speed control for the autonomous vehicle, window controls, driving controls, or driving mode selection controls.

13. The system of claim 8, wherein the physical input device of the autonomous vehicle comprises a button in the autonomous vehicle, a fingerprint sensor, or a camera in the autonomous vehicle.

14. The system of claim 8, wherein the permissions profile comprises rules for granting authorization for the user device to control the subset of the operational controls of the autonomous vehicle based on a location of the autonomous vehicle, a user account attribute, a user account type, or preferences of the user account.

15. A computer program product comprising a computer readable storage medium having program instructions embodied therewith, the program instructions executable by one or more processors to cause the one or more processors to perform operations comprising:
receiving a pairing request from a user device, a user account being associated with the user device;
receiving presence data from a physical input device in an autonomous vehicle indicating that a user is present in the autonomous vehicle;
in response to receiving the presence data, determining a permissions profile based on the user account and sensor data from the autonomous vehicle, the autonomous vehicle comprising operational controls;
identifying a subset of the operational controls of the autonomous vehicle available to the user device based on the user account and the permissions profile; and
authorizing the user device to control the subset of the operational controls of the autonomous vehicle.

16. The computer program product of claim 15, wherein the operations further comprise:
receiving a second presence data from the physical input device in the autonomous vehicle;
in response to receiving the second presence data, obtaining current sensor data from the autonomous vehicle and the user device;
determining that an emergency situation has occurred based on the current sensor data from the autonomous vehicle and the user device;
initiating a failover system that disables a primary system of the autonomous vehicle and activates a secondary subsystem; and
authorizing the user device to control operational controls for driving the autonomous vehicle using the secondary subsystem.

17. The computer program product of claim 16, wherein the secondary subsystem is a cloud service secondary subsystem or a locally-stored read-only clone copy of the primary system of the autonomous vehicle.

18. The computer program product of claim 16, wherein the operations further comprise:
generating a current status of the autonomous vehicle based on the current sensor data, wherein environmental data of the autonomous vehicle is obtained from the current sensor data; and
transmitting a message comprising the current status of the autonomous vehicle, the environmental data from the autonomous vehicle, and the user account associated with the user device to an external user support system associated with the autonomous vehicle for performance of remedial actions in response to the emergency situation.

19. The computer program product of claim 15, wherein the operational controls of the autonomous vehicle comprise wiper controls, music controls, light controls for inside the autonomous vehicle, a maximum speed control for the autonomous vehicle, window controls, driving controls, or driving mode selection controls.

20. The computer program product of claim 15, wherein the physical input device of the autonomous vehicle comprises a button in the autonomous vehicle, a fingerprint sensor, or a camera in the autonomous vehicle.
